(19) United States
(12) Patent Application Publication
(10) Pub. No.: US 2014/0179357 A1
(43) Pub. Date: Jun. 26, 2014

(54) Method And Apparatus For Reducing Page Messaging To User Equipment

(71) Applicants: Omar Hernando Salvador, Wheaton, IL (US); Keith R Stanley, Warrenville, IL (US); James P Knauft, Warrenville, IL (US)

(72) Inventors: Omar Hernando Salvador, Wheaton, IL (US); Keith R Stanley, Warrenville, IL (US); James P Knauft, Warrenville, IL (US)

(21) Appl. No.: 13/723,833

(22) Filed: Dec. 21, 2012

(51) Int. Cl. H04W 68/02

(52) U.S. Cl. CPC H04W 68/02
USPC 455/458

(57) ABSTRACT

Various methods and devices are provided to address some of the issues associated with paging for real time services. In one method, visited cell information is maintained (101) for a UE. A mobility level of the UE is then determined (102) using the visited cell information and at least one cell is selected (103) in which to page the UE based on the determined mobility level of the UE.

### FIELD OF THE INVENTION

The present invention relates generally to communications and, in particular, to paging in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Work is currently being done in the area of optimizing and minimizing the number of paging messages needed to support real time services (e.g., voice over LTE or via Circuit Switch Fallback (CSFB) mechanism). Using present-day paging methods, deployment of voice services is expected to introduce the following issues for wireless network operators: an increase of 5× in paging messages (compared to the current method used for best effort services, see more details below); a mobility management entity (MME) capacity impact due to the increase in paging signaling; an increase in the paging rate at eNodeBs (and at each cell); an increase in RF resources used for paging; and a decrease in user equipment (UE) battery life (with an increase in paging messages per cell, there is a higher probability that a UE has to decode paging frames for UEs other than itself).

To minimize paging messages, current paging methods can be “configured” (as allowed by standards) as follows: first attempt last seen eNodeB (eNB), second attempt last seen Tracking Area (TA), and third attempt last seen TA List. The overall paging rate depends on the success rate of the first page attempt and the TA size. Based on field observations, the first page attempt success rate is about 80%-85% (this mainly due to a high UE connection rate). This provides a “low” paging rate and tolerable delay for best effort services; however, to minimize the overall call setup delay for voice services (note that UEs will typically have a DRX cycle of 2.56 sec, which will further delay the paging response) operators expect a greater than 90% success rate for the first page attempt.

To achieve this success rate, current paging methods require the MME to send paging messages to all the eNodeBs in the entire TA List for the first and second attempt. The TA list typically includes a large number of eNodeBs (e.g., in the range of 50-100 eNBs), so this will trigger a large increase in paging messages sent to the eNodeBs, which are then “broadcast” in each cell. It is estimated that the above paging method (for voice services) will result in an increase of 5× (compared to the best effort paging method described above).

Another option that has been considered is to reduce the TA “size” (e.g., limit the number of eNodeBs per TA to a small number). However, this presents other issues, such as increased operational costs, increased UE registration rates (additional network and UE signaling triggered by TA updates), and increased difficulty in planning any TA expansions for small/metro cell deployments. Thus, new solutions and techniques that are able to address some of the issues associated with paging for real time services would meet a need and advance wireless communications generally.

### BRIEF DESCRIPTION OF THE DRAWINGS

FIG. 1 is a logic flow diagram of functionality performed by network equipment in accordance with various embodiments of the present invention.

FIG. 2 is a logic flow diagram of functionality performed by network equipment in accordance with some embodiments of the present invention.

FIG. 3 is a block diagram depiction of network equipment and user equipment in accordance with various embodiments of the present invention.

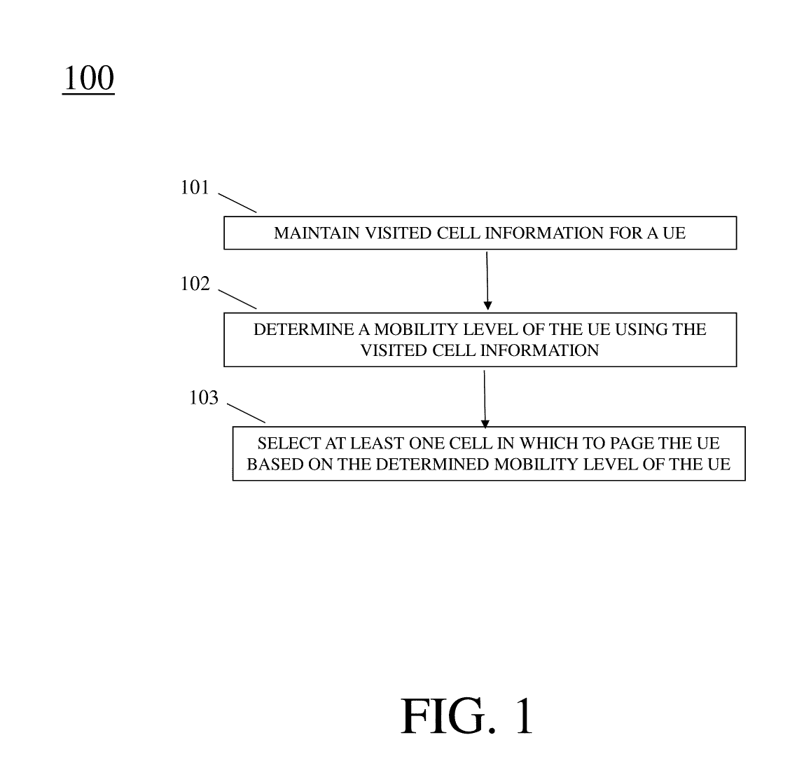

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address some of the issues associated with paging for real time services. In one method, visited cell information is maintained for a UE. A mobility level of the UE is then determined using the visited cell information and at least one cell is selected in which to page the UE based on the determined mobility level of the UE. An article of manufacture is also provided, the article comprising a processor-readable storage medium storing one or more software programs which when executed by one or more processors performs the steps of this method.

Many embodiments are provided in which the method above is modified. For example, in many embodiments maintaining visited cell information for the UE involves maintaining a list of N cells last visited by the UE. This may additionally involve maintaining information associated with the last N cells visited by the UE, such as cell identifying information, cell-type information, time-stamp information for UE activity, duration information for the UE visit, and/or UE activity-type information.

In many embodiments, determining the mobility level of the UE using the visited cell information involves determining the mobility level of the UE to be low when the visited cell information indicates that the UE has been active on the same cell or group of cells for a threshold period of time. In such embodiments, selecting at least one cell in which to page the UE may involve selecting the same cell or group of cells, in which to page the UE, that the UE has been active on for the threshold period of time.

In many embodiments, selecting at least one cell in which to page the UE based on the determined mobility level of the UE involves selecting the at least one cell in which to page the UE additionally based on whether a first page attempt for the UE has already been made and/or whether the UE is to be paged for a real-time service or for a best-effort service.

In many embodiments, the method also includes sending a paging message to a network node that identifies at least one cell, from the at least one cell selected, in which to page the UE. In such embodiments, the paging message may identify the at least one cell by including a cell identifier list.

A network equipment apparatus is also provided. The network equipment being configured to communicate with other equipment in the system and being operative to maintain visited cell information for a UE and to determine a mobility level of the UE using the visited cell information. The network equipment also being configured to select at least one cell in which to page the UE based on the determined mobility level of the UE. In some embodiments, the network equipment is, or includes, a mobility management entity (MME). Many embodiments are provided in which this network equipment apparatus is modified. Examples of such embodiments can be found described above with respect to the methods.

### DETAILED DESCRIPTION OF EMBODIMENTS

An approach to paging is described herein that seeks to reduce the eNB paging rate for best effort and real time services. The approach is based on UE activity and mobility patterns and is thought to reduce paging messages by 5 to 7 times what would otherwise be required.

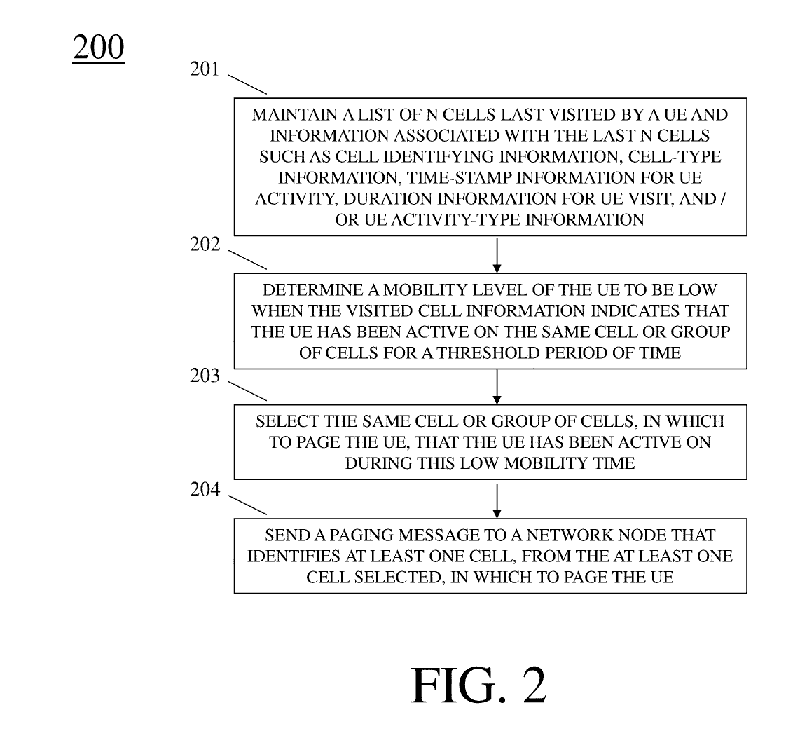

Aspects of embodiments of the present invention can be understood with reference to FIGS. 1 and 2. Diagram 100 of FIG. 1 is a logic flow diagram of functionality performed by network equipment in accordance with various embodiments of the present invention. In the method depicted in diagram 100, visited cell information is maintained (101) for a UE. A mobility level of the UE is then determined (102) using the visited cell information and at least one cell is selected (103) in which to page the UE based on the determined mobility level of the UE. By paging UEs in this manner system-wide, the lower mobility UEs can be paged in a more limited fashion while still attaining the desired success rate. Thus, the number of paging messages can be substantially reduced.

Many embodiments are provided in which the method above is modified. Some of these are illustrated in FIG. 2. In the method depicted in diagram 200, the network equipment maintains (201) a list of N cells last visited by a UE and information associated with the last N cells visited by the UE, such as cell identifying information, cell-type information, time-stamp information for UE activity, duration information for the UE visit, and/or UE activity-type information.

The network equipment determines (202) the mobility level of the UE to be low when the visited cell information indicates that the UE has been active on the same cell or group of cells for a threshold period of time. The network equipment then selects (203) the same cell or group of cells, in which to page the UE, that the UE has been active on for the threshold period of time and sends (204) a paging message to a network node that identifies at least one cell, from the at least one cell selected, in which to page the UE. In some embodiments, the paging message may identify the at least one cell by including a cell identifier list.

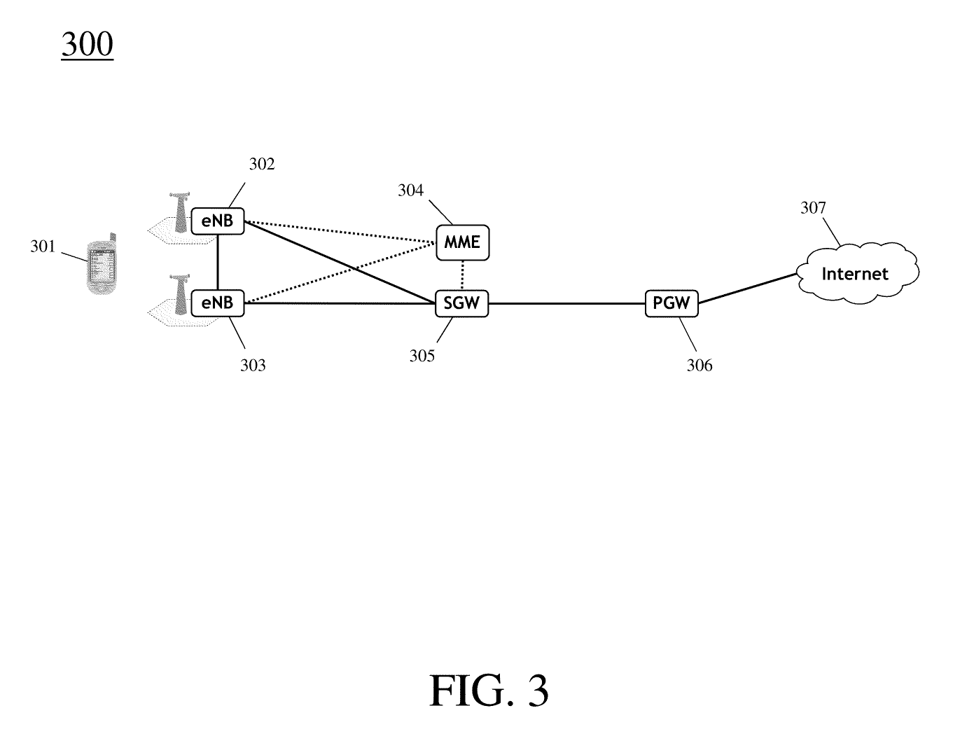

To provide a greater degree of detail in making and using various aspects of the present invention, a description of our approach to paging and a description of certain, quite specific, embodiments follows for the sake of example. FIG. 3 is referenced to illustrate an example of a specific system in which the present invention may be embodied.

FIG. 3 is a block diagram depiction of network equipment and user equipment in accordance with various embodiments of the present invention. The system depicted in diagram 300 includes an LTE wireless network providing service to mobile device (or UE) 301 via network nodes (or eNBs) 302 and 303. Also depicted is Mobility Management Entity (MME) 304, Serving Gateway (SGW) 305, and Packet Gateway (PGW) 306, connected to internet 307.

During busy periods in LTE networks one might expect to observe the following characteristics: UEs trigger frequent NAS connectivity (e.g., RRC connection requests)—about one connection request every 2 minutes (based on 10 sec inactivity timer). Less than 10% of the active UEs (UEs registered in the LTE network that trigger NAS connectivity) have medium/high speed mobility. The majority of active UEs (>90%) have low (pedestrian or lower) speed mobility. About 50% of the low speed mobility UEs usually are camped on the same cell/eNB (likely within the center of cell coverage). And the other 50% are at the edge of cell coverage (and these UEs are “toggling” between 1 or 2 eNBs). These UEs trigger about 90% of the mobility events (mostly due to ping-pong scenarios).

One proposed solution for LTE networks involves the MME maintaining a list, of last X “visited” cells per each registered UE including information such as: cell-/eNodeB-id, cell-type (e.g., macro, small, HeNB), time-stamp (when last time active), time UE stayed in cell, UE active (including HO events) on “last_seen_n_cells” (n can be in range of 2-3). The visited cell list information is created/maintained by the MME for each UE that is attached/registered in the network and is updated based on UE activity and mobility.

The MME is then able to determine the number of eNodeBs that need to be paged based on detected UE activity/mobility using information stored in the visited cell list information. For example:

UE active on same cell for a long period: the UE has low mobility and is within the center of cell coverage. The UE visited cell list information would indicate the UE was active on the same cell/eNodeB (e.g., all connection requests to same eNB), UE was active on same cell (e.g., last 3 cells are the same) and has been active on this cell for a long period (based on a configurable threshold) of time (e.g., given current UE activity, the threshold could be set to 5 minutes).

UE active on the same 2-4 cells (typically 1 or 2 eNBs) for a long period: the UE has low mobility and is at an edge of cell coverage (e.g., at the border of 2-3 cells). The visited cell list would have a few cell entries on which the UE was active, and the UE was active on the same cells/eNodeBs (e.g., determined from the UE last_seen_n_cells).

UE camped on different cells/eNBs for a long period: the UE is moving (at medium/high speed) across the coverage of multiple cells. The visited cell list would have several cell entries on which the UE was last active and the UE “last_seen_n_cells” entries would indicate UE mobility across different eNBs.

For the UEs detected to have low speed mobility, the number (N) of last visited eNBs is expected to be in the range of 1-3 eNBs in most cases. Using a first page attempt with these last N visited eNBs (for MME paging) would result in a high success rate (similar to paging the entire TA list). For UEs detected with medium/high speed triggering mobility events (which account for less than 10% of the registered UEs), it is likely that while the UE is in idle it will be “moving” across different cells/eNBs that may not be included in the current last visited cell list. Therefore, for these UEs, it would be better to page the TA List in the first page attempt.

To further reduce the number of messages sent over the air interface (especially for deployments where the eNB supports more than one carrier), the MME can specify the cell-id list on the paging message to the eNB. In most cases, the cell-id list will contain one cell-id (the cell on which the UE is likely camping).

Various embodiments of this approach are envisioned that further consider how many paging attempts have been made and also whether the paging is for real-time services or best-effort services. For example, in some embodiments, an MME may handle paging for real-time services as follows:

For UEs detected to have low speed mobility:
MME, for first page attempt, sends paging messages to last N visited eNodeBs.
MME, for second page attempt, will send paging messages to all eNodeBs in the current TA List.
Based on a configurable option: MME for third page attempt may page all eNodeBs in current TA List.

For UEs detected to have medium/high speed mobility:
MME, for first page attempt, will send paging messages to all eNodeBs in the current TA List.
MME, for second page attempt, will send paging messages to all eNodeBs in the current TA List.
   In some embodiments, an MME may handle paging for best-effort services as follows:

For UEs detected to have low speed mobility:
MME, for first page attempt, sends paging messages to last N visited eNodeBs.
Based on an operator configurable option: MME, for second page attempt, may send paging messages to last N visited cells or to all eNodeBs in the current TA List.
Based on a configurable option: MME, for third page attempt, may page all eNodeBs in the current TA List.

For UEs detected to have medium/high speed mobility:
Based on an operator configurable option: MME, for first page attempt, may send paging messages to last N visited cells or to all eNodeBs in the current TA List.
Based on an operator configurable option, MME, for second page attempt, may send paging messages to last N visited cells or to all eNodeBs in the current TA List.
   Also, in some embodiments, the MME sends a cell-id list in the paging message to the eNB. This can be applied to all of the paging embodiments described above. When an eNB receives a paging message with a cell-id list, the eNB will send the paging message only on the cells specified in the cell-id list.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for reducing page messaging to user equipment (UE), the method comprising:
maintaining visited cell information for a UE;
determining a mobility level of the UE using the visited cell information;
selecting at least one cell in which to page the UE based on the determined mobility level of the UE.

2. The method as recited in claim 1, wherein maintaining visited cell information for the UE comprises
maintaining a list of N cells last visited by the UE.

3. The method as recited in claim 2, wherein maintaining a list of N cells last visited by the UE comprises
maintaining information associated with the last N cells visited by the UE, the information being of at least one type from the group of
cell identifying information,
cell-type information,
time-stamp information for UE activity,
duration information for UE visit, and
UE activity-type information.

4. The method as recited in claim 1, wherein determining the mobility level of the UE using the visited cell information comprises
determining the mobility level of the UE to be low when the visited cell information indicates that the UE has been active on the same cell or group of cells for a threshold period of time.

5. The method as recited in claim 4, wherein selecting at least one cell in which to page the UE comprises
selecting the same cell or group of cells, in which to page the UE, that the UE has been active on for the threshold period of time.

6. The method as recited in claim 1, wherein selecting at least one cell in which to page the UE based on the determined mobility level of the UE comprises
selecting the at least one cell in which to page the UE additionally based on whether a first page attempt for the UE has already been made.

7. The method as recited in claim 6, wherein selecting at least one cell in which to page the UE based on the determined mobility level of the UE comprises
selecting the at least one cell in which to page the UE additionally based on whether the UE is to be paged for a real-time service or for a best-effort service.

8. The method as recited in claim 1, further comprising
sending a paging message to a network node that identifies at least one cell, from the at least one cell selected, in which to page the UE.

9. The method as recited in claim 8, wherein the paging message identifies the at least one cell by including a cell identifier list.

10. Network equipment in a communication system, the network equipment being configured to communicate with other equipment in the system, wherein the network equipment is operative
to maintain visited cell information for a UE (user equipment),
to determine a mobility level of the UE using the visited cell information, and
to select at least one cell in which to page the UE based on the determined mobility level of the UE.

11. The network equipment as recited in claim 10, wherein the network equipment comprises a mobility management entity (MME).

12. The network equipment as recited in claim 10, wherein being operative to maintain visited cell information for the UE comprises
being operative to maintain a list of N cells last visited by the UE.

13. The network equipment as recited in claim 12, wherein being operative to maintain a list of N cells last visited by the UE comprises
being operative to maintain information associated with the last N cells visited by the UE, the information being of at least one type from the group of
cell identifying information,
cell-type information,
time-stamp information for UE activity,
duration information for UE visit, and
UE activity-type information.

14. The network equipment as recited in claim 10, wherein being operative to determine the mobility level of the UE using the visited cell information comprises
being operative to determine the mobility level of the UE to be low when the visited cell information indicates that the UE has been active on the same cell or group of cells for a threshold period of time.

15. The network equipment as recited in claim 14, wherein being operative to select at least one cell in which to page the UE comprises
being operative to select the same cell or group of cells, in which to page the UE, that the UE has been active on for the threshold period of time.

16. The network equipment as recited in claim 10, wherein being operative to select at least one cell in which to page the UE based on the determined mobility level of the UE comprises
being operative to select the at least one cell in which to page the UE additionally based on whether a first page attempt for the UE has already been made.

17. The network equipment as recited in claim 16, wherein being operative to select at least one cell in which to page the UE based on the determined mobility level of the UE comprises
being operative to select the at least one cell in which to page the UE additionally based on whether the UE is to be paged for a real-time service or for a best-effort service.

18. The network equipment as recited in claim 10, wherein the network equipment is further operative
to send a paging message to a network node that identifies at least one cell, from the at least one cell selected, in which to page the UE.

19. The network equipment as recited in claim 18, wherein the paging message identifies the at least one cell by including a cell identifier list.
